(19) United States
(12) Patent Application Publication
(10) Pub. No.: US 2011/0216422 A1
(43) Pub. Date: Sep. 8, 2011

(54) Image Display Device

(75) Inventor: Rika Nakazawa, Nagoya-shi (JP)

(73) Assignee: BROTHER KOGYO KABUSHIKI KAISHA, Nagoya-shi (JP)

(21) Appl. No.: 13/038,464

(22) Filed: Mar. 2, 2011

(30) Foreign Application Priority Data
Mar. 2, 2010 (JP) 2010-045193

(51) Int. Cl. G02B 27/02; G02B 25/00

(52) U.S. Cl. 359/643

(57) ABSTRACT

An image display device may include an image generator, an ocular lens, an optical unit and a lens barrel. The optical unit may be disposed in an area between the image generator and the ocular lens. The optical unit may include at least one of an exit pupil expander and a mask in one or more arrangements. The lens barrel, when housing the ocular lens and the optical unit, may include an inner circumferential surface on which the ocular lens is supported to be rotatable around the optical axis thereof. The optical unit may, in some examples, be fixed to the ocular lens. A rotational position of the optical unit around the optical axis of the ocular lens is adjustable by rotating the ocular lens.

### CROSS-REFERENCE TO RELATED APPLICATION

This Application claims priority from JP 2010-045193, filed on Mar. 2, 2010, the content of which is hereby incorporated by reference.

### BACKGROUND OF THE DISCLOSURE

1. Field of the Disclosure

The invention generally relates to a retinal scanning image display device. In particular, aspects described herein relate to a configuration of an optical unit and an ocular lens in such a device.

2. Description of the Related Art

A head mounted display (HMD), which is mounted on a head of a viewer, allows the viewer to perceive an image, is known. As an example of the HMD, a retinal scanning display (RSD) acting as a retinal scanning image display device is generally configured to cause scanned light beams to be incident on a viewer's eye and projected onto the retina, thereby allowing the viewer to perceive an image represented by the scanned light beams. In one example, an optical system of the RSD forms an intermediate image surface which is optically conjugate with a final image surface to be formed on the viewer's retina. One or more light beams which form the intermediate image surface in the optical system of the RSD is caused to be incident on the viewer's eye via an ocular lens or other lens, thereby forming the final image surface on the retina.

Some RSDs include an optical unit in the optical system at a position where the intermediate image surface is formed. The optical unit includes an exit pupil expander and a mask. The exit pupil expander is configured to enlarge an effective diameter of the exit pupil, which is formed by the ocular lens, by dividing or diffusing a light beam. The mask shields the periphery of the image based on the scanned light beam. The optical unit may include an exit pupil expander formed by a diffraction grating and/or a frame-shaped mask which are integrated with each other.

In some RSDs, the optical unit and the ocular lens of the optical system are separately assembled to a lens barrel provided to house the optical unit and the ocular lens. The optical unit and the ocular lens are therefore individually positioned with respect to the lens barrel. In many arrangements, the ocular lens has a circular outer shape when viewed along the optical axis. The optical unit, on the other hand, may be rectangular in shape when viewed along the optical axis if, for example, the optical unit includes an exit pupil expander having a diffraction grating. The rectangular shape may allow for easier recognition of a directivity of the diffraction element.

Thus, according to some of the above arrangements, there may be some difficulty in assembling the optical unit and the ocular lens which constitute the optical system of the RSD to the lens barrel and in positioning the various components with sufficient positioning accuracy due to the difference in shape. Because the image is displayed at the center of the optical unit in the optical system of the RSD, if the positioning accuracy between the optical unit and the ocular lens is low or poor, positional misalignment will occur between the center positions of the exit pupil expander and the mask and the optical axis of the ocular lens. As a result, image quality may be impaired. Image quality impairment may be especially evident and problematic when the optical unit is mounted on the lens barrel in a misaligned (i.e., tilted) manner in a rotational direction around the optical axis with respect to a display image (i.e., in a scanning direction). In particular, positional adjustment may be difficult due to the rectangular outer shape of the optical unit.

According to some arrangements, a viewer is able to recognize the horizontal and vertical orientations of an image based on an area shielded with a mask on the display screen. With such a mask, misalignment of the optical unit will give the viewer a feeling that the image itself is tilted. In an optical unit with an exit pupil expander, when the exit pupil expander is tilted toward the center of the optical axis with respect to the display image (i.e., in the scanning direction), desired diffraction characteristics cannot be provided and image quality may be impaired.

Techniques for the adjustment of the optical axis of a diffraction grating have been proposed. For example, Japanese Unexamined Patent Application Publication No. 1996-129114 discloses a structure composed of a holder and a lens barrel. The holder supports a diffraction grating and the lens barrel houses the lens and/or other components while supporting the holder. The holder and the lens barrel are relatively rotatable via a spherical receiving surface. With the disclosed technique, it may be possible to increase positioning accuracy between the optical unit and the ocular lens which altogether constitute the optical system of the RSD as described above.

In the technique disclosed in Japanese Unexamined Patent Application Publication No. 1996-129114, the holder which supports the diffractive grating is provided separately from the lens barrel which houses the lens and/or other components. If the disclosed technique is adopted for an RSD, the member supporting the optical unit and the member supporting the ocular lens will be separately provided. Accordingly, the disclosed technique may provide a complicated structure in the optical system and is therefore unsuitable for the RSD for which size reduction is demanded. At the same time, a structure in which the optical unit and the ocular lens are housed in a single lens barrel without any components through which their positional relationship along multiple axes may be determined may have the problem described above. Without such components, proper alignment between the ocular lens and the optical unit may be difficult.

### SUMMARY OF THE DISCLOSURE

The present disclosure provides an image display device in which an optical system thereof includes an optical unit and an ocular lens. The optical unit and the ocular lens may be easily assembled to a lens barrel, and positional adjustment of the optical unit along a rotational direction may be easier. Additionally, positioning accuracy of the optical unit and the ocular lens with respect to the lens barrel is increased.

According to one or more aspects, in order to achieve such an image display device, an image display device may include a light source section, a scanning section, an ocular lens, an optical unit and a lens barrel. The light source section is configured to emit a light beam with intensity based on the image signal while the scanning section is configured to two-dimensionally scan the light beam emitted from the light source section. The ocular lens may subsequently cause the light beam scanned by the scanning section to be projected incident to a viewer's eye. The optical unit may be disposed in a vicinity of an image surface position (e.g., where the image is properly formed (such as being in focus) prior to being projected incident to the viewer's eye) located between the scanning section and the ocular lens. According to one or more arrangements, the optical unit may include at least one of an exit pupil expander and a mask. The exit pupil expander is configured to enlarge an effective diameter of the exit pupil, which is formed by the ocular lens, by branching the light beam. The mask, on the other hand, is configured to shield a periphery of the image based on the light beam scanned by the scanning section. The lens barrel houses the ocular lens and the optical unit. The ocular lens may have a circular outer shape when viewed along the optical axis of the ocular lens. The lens barrel may include an inner circumferential surface on which the ocular lens is supported so as to be rotatable around the optical axis thereof in a state where an outer circumferential surface of the ocular lens is in contact with the inner circumferential surface of the lens barrel. In some examples, the optical unit may further be fixed to the ocular lens. Moreover, a rotational position of the optical unit around the optical axis of the ocular lens may be adjustable by rotating the ocular lens supported on the inner circumferential surface of the lens barrel.

According to another aspect, an image display device may include a light source section, a scanning section, an ocular lens, an optical unit and a lens barrel. The optical unit may include an optical effect device which produces an optical effect having directivity to at least a portion of the light beam (e.g., causing the light beam to be asymmetrical along at least one axis perpendicular to an optical axis) while the lens barrel may house the ocular lens and the optical unit. The ocular lens has a circular outer shape when viewed along the optical axis of the ocular lens. The lens barrel includes an inner circumferential surface on which the ocular lens is supported to be rotatable around the optical axis thereof in a state where an outer circumferential surface of the ocular lens is in contact with the inner circumferential surface of the lens barrel. In some arrangements, the optical unit may be fixed to the ocular lens. A rotational position of the optical unit around the optical axis of the ocular lens is adjustable by rotating the ocular lens supported on the inner circumferential surface of the lens barrel.

### BRIEF DESCRIPTION OF THE DRAWINGS

For a more complete understanding of the invention, the needs satisfied thereby, and the objects, features, and advantages thereof, reference now is made to the following description taken in connection with the accompanying drawings.

FIG. 1 illustrates an overall structure of an example RSD according to an embodiment of the invention.

FIG. 2 is a front view illustrating an example structure of an optical unit according to an embodiment of the invention.

FIG. 3 is a perspective view illustrating an example structure of the optical unit according to the embodiment of the invention.

FIG. 4 illustrates an example display screen according to the embodiment of the invention.

FIG. 5 is a perspective view of an example ocular lens according to the embodiment of the invention.

FIG. 6 is a perspective view of an integrated structure of an example ocular lens and optical unit according to the embodiment of the invention.

FIG. 7 is a front view of a casing of an optical unit according to the embodiment of the invention.

FIG. 8 is a perspective view of an example casing of an optical unit according to the embodiment of the invention.

FIG. 9 is a front view of an integrated structure of an example ocular lens and optical unit according to the embodiment of the invention.

FIG. 10 schematically illustrates a mounted state of an example ocular lens and optical unit according to the embodiment of the invention.

FIG. 11 schematically illustrates a state in which an example ocular lens and optical unit are housed in a lens barrel according to the embodiment of the invention.

FIG. 12 is a perspective view illustrating an example lens barrel according to the embodiment of the invention.

FIG. 13 illustrates an exemplary method of adjusting a rotational position of the optical unit according to the embodiment of the invention.

FIG. 14 illustrates a further exemplary method of adjusting a rotational position of the optical unit according to the embodiment of the invention.

FIG. 15 illustrates another example image display device having an LCD image generator according to an embodiment of the invention.

### DETAILED DESCRIPTION

According to one or more aspects of the present disclosure, an optical unit and an ocular lens may be integrated with each other in an optical system of an RSD. Moreover, an outer shape of the ocular lens may be used for positional alignment of the optical unit and the ocular lens with respect to a lens barrel. With this structure, the optical unit and the ocular lens may be more easily assembled with increased positioning accuracy. An RSD according to one or more embodiments of the present disclosure will be described herein with reference to the drawings. The drawings are provided to illustrate technical features which may be adopted by the present disclosure. Structures of the apparatus in the drawings are illustrative only and not intended to be limiting. For example, a part of the structure of the RSD described herein may be omitted or replaced by another structure. Alternatively, the RSD may include other/additional structures.

### Example Structure of an RSD

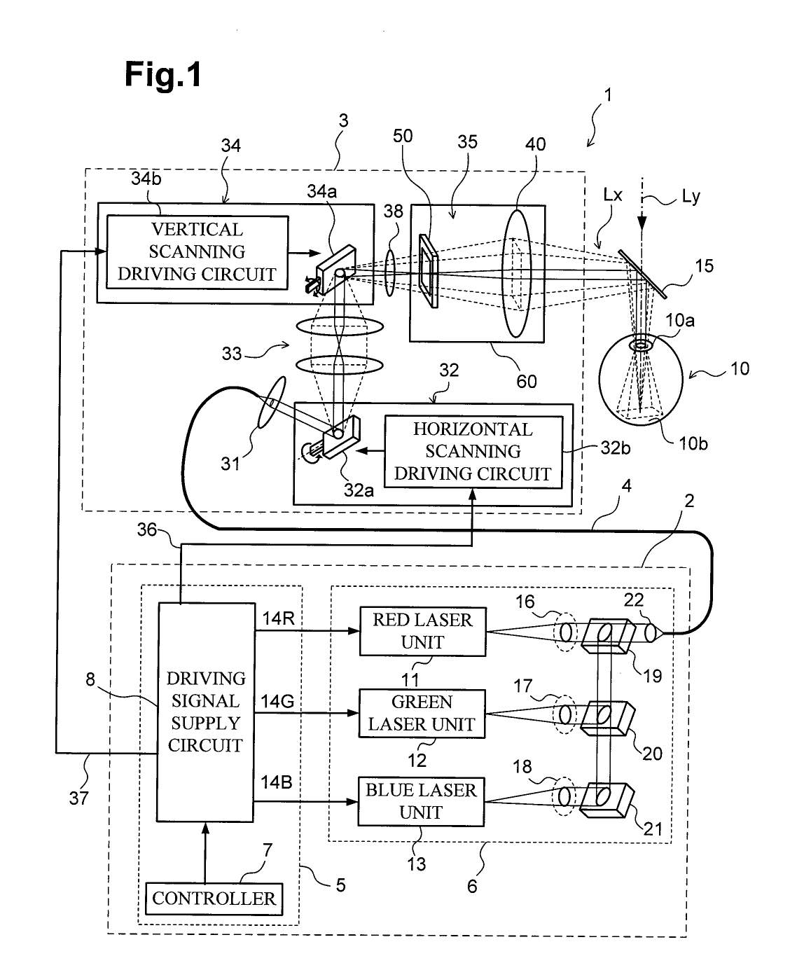

The structure of an RSD 1 acting as an image display device according to the present embodiment will be described with reference to FIG. 1. The RSD 1 is configured to project an image onto a retina of a viewer's eye. The RSD 1 causes laser light which includes a scanned light beam to be incident on a pupil and projected onto the retina, whereby the viewer may recognize and perceive the image. In particular, the RSD 1 may include a retinal scanning image display device which scans the viewer's retina at high speed with weak light, thereby causing the viewer to recognize and perceive a residual image of the irradiated light.

As illustrated in FIG. 1, the RSD 1 includes a control unit 2 and a projection unit 3. The control unit 2 emits laser light of intensity based on an image signal as image light. In one or more arrangements, the image light emitted from the control unit 2 may be transmitted to the projection unit 3 via an optical fiber cable 4.

The control unit 2 may include a storage section and may be configured to generate an image signal in accordance with, for example, content data stored in the storage section. The control unit 2 emits, toward the optical fiber cable 4, laser light of intensity based on the generated image signal as the image light.

The projection unit 3 scans the image light transmitted via the optical fiber cable 4 to cause the image light to be perceivable and recognizable by the viewer as a display image. The projection unit 3 two-dimensionally scans the image light of which intensity has been modulated for each color of red (R), green (G) and blue (B) and/or other colors in the control unit 2 and causes the scanned image light to be incident on a viewer's eye 10.

Electrical and optical structures of the RSD 1 are described in further detail below. According to one or more aspects, the control unit 2 may include a drive controller 5 and a light source section 6. The drive controller 5 may include a controller 7 and a driving signal supply circuit 8.

In one or more arrangements, the controller 7 may be configured to control components of the RSD 1 comprehensively. For example, the controller 7 may control one or more components of the RSD 1 through execution of a predetermined process in accordance with a previously-stored control program and instructions. The controller 7 may include various functional components, such as a CPU (central processing unit), flash memory, a RAM (random access memory), a VRAM (video RAM) and one or more I/O (input/output) interfaces connected by a data communication bus (not shown). The controller 7 transmits and receives data via the bus. Various pieces of image data, such as image data supplied from unillustrated external equipment connected via, for example, an I/O terminal and image data based on previously-stored content data may be input to the controller 7. The controller 7 may subsequently generate an image signal S which is based on the input image data. The image signal S generated by the controller 7 is then sent to the driving signal supply circuit 8.

The driving signal supply circuit 8 functions as a driving signal generating unit which generates a driving signal based on the image signal S. The driving signal supply circuit 8 generates, for each pixel, a signal based on the image signal S as a factor for the generation of the display image.

The light source section 6 outputs laser light as a light beam of intensity based on the driving signal generated by the driving signal supply circuit 8. The light source section 6 includes a red laser unit 11 which generates and emits red laser light, a green laser unit 12 which generates and emits green laser light and a blue laser unit 13 which generates and emits blue laser light. Light source section 6 may include additional or alternative color laser units as needed or desired. Furthermore, the light source section 6 may include LEDs (light emitting diodes), fluorescent bulbs, high intensity discharge (HID) lighting, organic LEDs and other light sources.

Each of the laser units 11, 12 and 13 includes a laser for generating laser light of the corresponding color and a laser driver for driving the laser. The lasers of the laser units 11, 12 and 13 are, for example, semiconductor lasers or solid state lasers with a harmonic generating function. The laser drivers of laser units 11, 12 and 13 supply a driving current to the corresponding laser 11, 12 or 13 in accordance with the driving signal input from the driving signal supply circuit 8. Furthermore, the lasers of the laser units 11, 12 and 13 emit laser light of modulated intensity which is based on the driving current supplied to the laser from the laser driver. In particular, the red laser unit 11 causes the laser driver to drive the laser in accordance with the driving signal 14R supplied from the driving signal supply circuit 8 to emit red laser light. The green laser unit 12 causes the laser driver to drive the laser in accordance with the driving signal 14G supplied from the driving signal supply circuit 8 to emit green laser light. The blue laser unit 13 causes the laser driver to drive the laser in accordance with the driving signal 14B supplied from the driving signal supply circuit 8 to emit blue laser light. If semiconductor lasers are employed for the laser units 11, 12 and 13, intensity of the laser light may be modulated through a direct modulation of the driving current. If solid state lasers are employed, each laser may be equipped with an external modulator for the intensity modulation of the emitted laser light.

The light source section 6, in one or more arrangements, multiplexes the laser light from the laser units 11, 12 and 13 and emits the multiplexed laser light toward the optical fiber cable 4. The light source section 6 includes collimating optical systems 16, 17 and 18, dichroic mirrors 19, 20 and 21 and a coupling optical system 22. The laser light of each color emitted from each of the laser units 11, 12 and 13 is collimated by the corresponding collimating optical system 16, 17 and 18, respectively, and is caused to be incident on the corresponding dichroic mirror 19, 20 or 21, respectively. Each of the red, green and blue laser light incident on the corresponding dichroic mirror 19, 20 or 21 are selectively reflected or transmitted based on the wavelength. For example, the dichroic mirror 19, 20 or 21 might only reflect or transmit light of a specific range of wavelengths. The laser light then reaches the coupling optical system 22 where it is multiplexed and condensed. The laser light condensed by the coupling optical system 22 then enters the optical fiber cable 4. In particular, the laser light of each color with modulated intensity emitted from the light source section 6 is multiplexed into the laser light which enters the optical fiber cable 4.

The structure of the optical system which emits the laser light from the laser units 11, 12 and 13 as the light emitted from the light source section 6 is not limited to that described above. Any structures capable of selectively reflecting or transmitting the laser light based on the wavelength or color of the laser light emitted from the laser units 11, 12 or 13 may be employed. As described above, in one example, the light source section 6 emits the laser light of intensity based on the image signal S input from the controller 7.

As shown in FIG. 1, the projection unit 3 is disposed between the light source section 6 and the viewer's eye 10 on an optical path of the RSD 1. In the illustrated example embodiment, the projection unit 3 includes a collimating optical system 31, a horizontal scanning section 32, a first relay optical system 33, a vertical scanning section 34 and a second relay optical system 35.

The collimating optical system 31 collimates the laser light which is generated by the light source section 6 and output from the optical fiber cable 4. The horizontal scanning section 32 reciprocatingly scans the laser light collimated by the collimating optical system 31 in a horizontal direction to form a display image. The first relay optical system 33 is disposed between the horizontal scanning section 32 and the vertical scanning section 34 and relays the laser light.

The vertical scanning section 34 scans, in a vertical direction, the laser light which has been scanned in the horizontal direction by the horizontal scanning section 32. The second relay optical system 35 causes the laser light which has been scanned in the horizontal direction by the horizontal scanning section 32 and in the vertical direction by the vertical scanning section 34 to be emitted outside of the projection unit 3.

The horizontal scanning section 32 and the vertical scanning section 34 are light scanning devices and the first relay optical system 33 is an optical system. In one example, both of the horizontal scanning section 32 and the vertical scanning section 34 scan the laser light output from the optical fiber cable 4 in the horizontal and vertical directions to form a scanned light beam in order to cause the laser light to be projectable as an image onto the viewer's retina 10b. Thus, in the present example embodiment, the structure including the horizontal scanning section 32 and the vertical scanning section 34 functions as an exemplary scanning section which two-dimensionally scans the laser light emitted from the light source section 6. According to one or more arrangements, the horizontal scanning section 32 and the vertical scanning section 34 may be formed as two individual and separate one-dimensional scanning sections. In another arrangement, the horizontal scanning section 32 and the vertical scanning section 34 are integrally formed through a single reflective surface that is configured to rotate in multiple directions (e.g., horizontally and vertically). In the following description, the structure including the horizontal scanning section 32 and the vertical scanning section 34 will be collectively referred to as the “scanning section.” Note that the scanning section may include and/or be implemented by other structures. For example, a two-dimensional light scanning device which two-dimensionally scans the laser light in the horizontal and vertical directions may be employed as the scanning section as an alternative to the horizontal scanning section 32 and the vertical scanning section 34.

The horizontal scanning section 32 includes a resonant deflection element 32a and a horizontal scanning driving circuit 32b. The deflection element 32a includes a deflection surface on which the laser light is scanned in the horizontal direction. The horizontal scanning driving circuit 32b generates a driving signal which resonates the deflection element 32a and causes fluctuations in the deflection surface (i.e., a reflective surface) of the deflection element 32a. The horizontal scanning driving circuit 32b generates the driving signal for the deflection element 32a in accordance with a horizontal driving signal 36 input from the driving signal supply circuit 8. The shape and the drive system (for example, a piezoelectric system, an electromagnetic system and an electrostatic system) of the deflection element 32a are not particularly limited.

The vertical scanning section 34 includes a dissonance deflection element 34a and a vertical scanning driving circuit 34b. The deflection element 34a includes a deflection surface (i.e., a reflective surface) on which the laser light is scanned in the vertical direction. The vertical scanning driving circuit 34b generates the driving signal which causes fluctuations in the deflection surface of the deflection element 34a in a dissonant state. The vertical scanning driving circuit 34b generates a driving signal for the deflection element 34a in accordance with a vertical driving signal 37 input from the driving signal supply circuit 8. The shape and the drive system (for example, a piezoelectric system, an electromagnetic system and an electrostatic system) of the deflection element 34a are not particularly limited.

The vertical scanning section 34 scans each frame of the image to be displayed with the laser light in the vertical direction from the first horizontal scanning line toward the last horizontal scanning line. In this manner, a two-dimensionally scanned image is formed. The term “horizontal scanning line” may correspond to one scanning event (e.g., a single pass across the image area) in the horizontal direction by the horizontal scanning section 32.

According to one or more aspects, the first relay optical system 33 may cause the laser light, which has been horizontally scanned on the deflection surface of the deflection element 32a of the horizontal scanning section 32, to converge onto the deflection surface of the deflection element 34a of the vertical scanning section 34. The laser light converged onto the deflection surface of the deflection element 34a is then scanned in the vertical direction by the deflection surface of the deflection element 34a, whereby image light Lx is formed.

The second relay optical system 35 may include a correction lens 38 and an ocular lens 40 of positive refractivity which are arranged serially. After passing through the second relay optical system 35, the laser light (e.g., image light Lx), is reflected by a half mirror 15 of the RSD 1 and is caused to be incident on the viewer's pupil 10a. When the image light Lx is caused to be incident on the pupil 10a, the display image based on the image signal S is projected onto the retina 10b. In this manner, the viewer perceives and recognizes the image light Lx as a display image.

In one example, the half mirror 15 may cause outside light Ly to transmit and to be incident on the viewer's eye 10. With this structure, the viewer recognizes the image based on the image light Lx as overlapping with a background recognized in accordance with the outside light Ly. As described above, the RSD 1 of the present embodiment may be a see-through system which scans the viewer's eye 10 with the image light Lx emitted from the projection unit 3 and causes the image light Lx to be projected onto the viewer's eye 10 while transmitting the outside light Ly. However, the RSD 1 is not limited to such see-through systems.

In one or more configurations, the correction lens 38 may be located at a side of the second relay optical system 35 where the light is incident on the second relay optical system 35. The correction lens 38 is provided for a curved surface correction of the image which is based on the image light and the ocular lens 40 causes the image light Lx (e.g., the laser light scanned by the scanning section) to be incident on the viewer's eye 10. The ocular lens 40 thus functions as an ocular optical system which projects the image based on the image signal S onto the viewer's retina 10b.

In the second relay optical system 35, an intermediate image surface may be formed between the correction lens 38 and the ocular lens 40. The intermediate image surface is optically conjugate with a final image surface to be formed on the viewer's retina 10b. That is, the laser light which forms the intermediate image surface in the optical system of the RSD 1 is caused to be incident on the viewer's eye 10 via an ocular lens 40 and forms the final image surface on the retina 10b.

The RSD 1 includes an optical unit 50 which is disposed in a vicinity area between the correction lens 38 and the ocular lens 40. The vicinity area includes a position at which the intermediate image surface will be formed. In the present embodiment, for example, the optical unit 50 is disposed between the correction lens 38 and the ocular lens 40 at a position at which the intermediate image surface will be formed. However, the optical unit 50 may be disposed at any position in the vicinity area. is the vicinity area, as used herein, may include an area in which the optical unit 50, if disposed in this area, can produce a desired optical effect on the image light Lx. In one example, the optical unit 50 may enlarge an effective diameter of the exit pupil, formed by the ocular lens 40, by dividing or diffusing the laser light. Thus, in the present embodiment, the structure including the second relay optical system 35 and the optical unit 50 functions as a projecting section which projects the laser light scanned by the scanning section onto the retina 10b of the viewer's eye 10, thereby allowing a viewer to perceive and recognize an image corresponding to the projected laser light.

The RSD 1 may also include a lens barrel 60 in which the ocular lens 40 and the optical unit 50 are housed. For example, the lens barrel 60 may be a substantially cylindrical member which supports, in the second relay optical system 35, the ocular lens 40 and the optical unit 50 such that the laser light emitted from the vertical scanning section 34 might be incident on the optical unit 50 and the ocular lens 40.

The thus-structured RSD 1 may include, for example, an eyeglass frame which supports the structure including the projection unit 3, thereby forming a head mounted display to be mounted on a viewer's head.

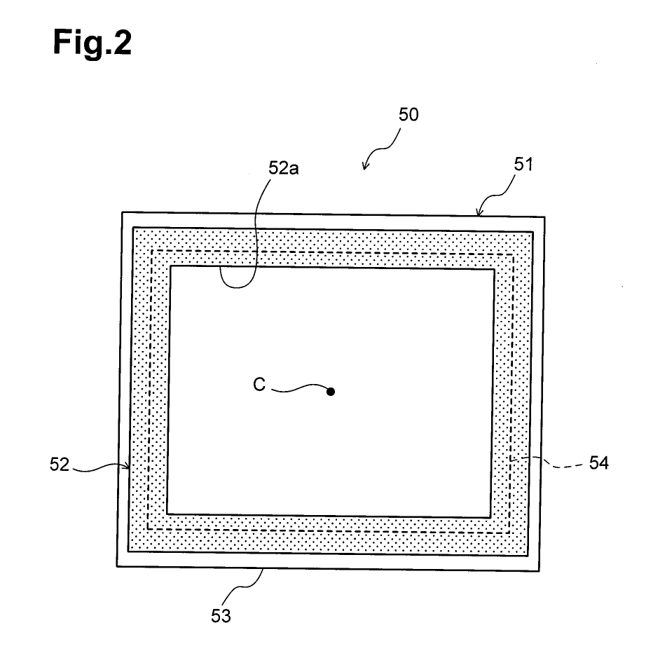

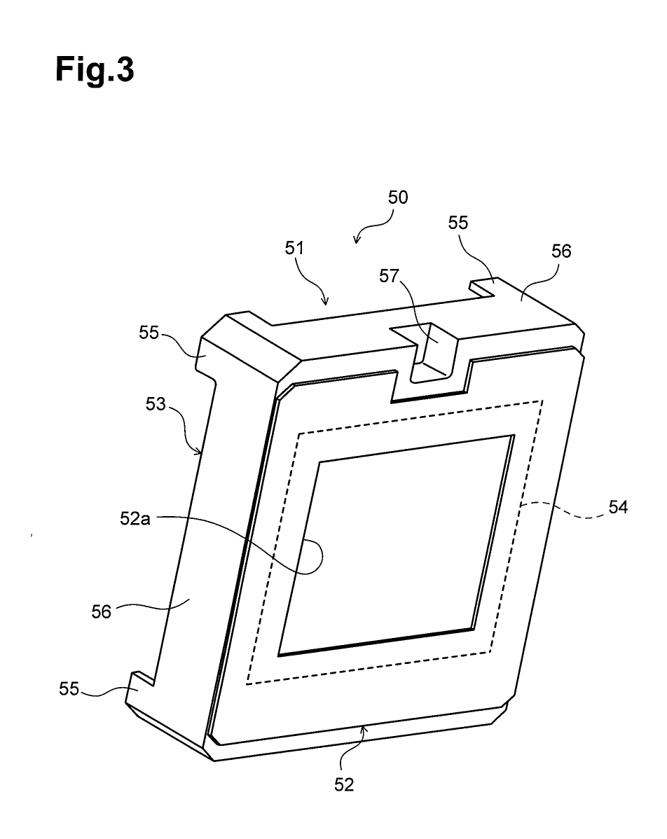

The optical unit 50 is described in further detail with reference to FIGS. 2 and 3. In the RSD 1, the optical unit 50 is disposed in the image surface position defined between the scanning section and the ocular lens 40 (see FIG. 1). The image surface position includes a position at which the intermediate image surface is formed in the second relay optical system 35.

As illustrated in FIGS. 2 and 3, the example optical unit 50 includes an exit pupil expander 51 and a mask 52 which are formed in an integrated manner. The exit pupil expander 51 enlarges an effective diameter of the exit pupil, which is formed by the ocular lens 40, by branching the incident laser light. Note that the optical unit 50 may be formed by either of the exit pupil expander 51 or the mask 52. The optical unit 50 may be formed by other optical elements which produce an optical effect which has directivity, e.g., which is not rotationally symmetric (e.g., a polarizing plate and a cylindrical lens) as long as a desired function is satisfied.

The exit pupil expander 51 includes a substantially rectangular plate-shaped casing 53 and a diffraction grating 54 supported by the casing 53. The diffraction grating 54 is formed as a rectangular plate and is mounted on the casing 53 with horizontal and vertical orientations being in accordance with those of the casing 53. Thus, the exit pupil expander 51 may be formed in a substantially rectangular plate shape as a whole by the casing 53 on which the diffraction grating 54 is mounted.

The mask 52 is generally configured to shield the periphery of the image based on the light beam scanned by the scanning section. For example, the mask 52 may be a thin plate-shaped light shielding member formed as a rectangular frame corresponding to the outer shape of the exit pupil expander 51. That is, the mask 52 may be formed in a rectangular, surrounding shape.

The mask 52 is attached and fixed to one side of the exit pupil expander 51. In a state where the mask 52 is attached to the exit pupil expander 51, an opening 52a of the frame-shaped mask 52 provides a portion through which the laser light transmits in the optical unit 50.

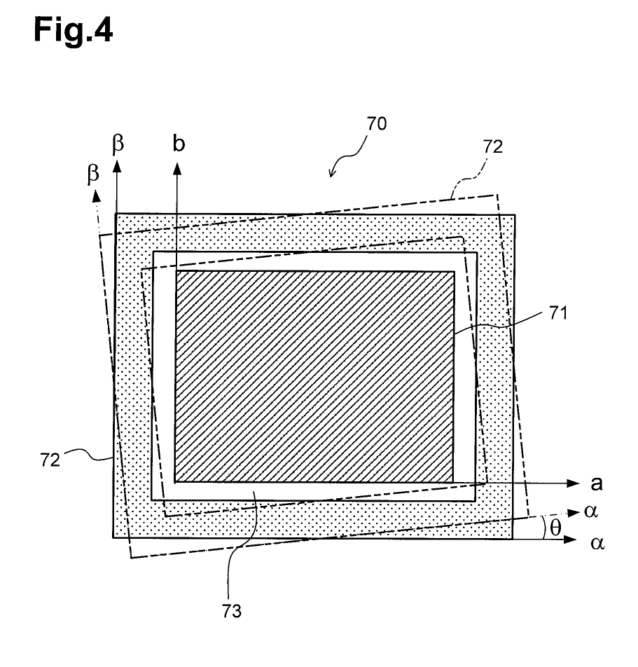

The mask 52 forms an image frame which is disposed along the margin of the image in the display screen of the RSD 1. In particular, as illustrated in FIG. 4, the mask 52 forms an image frame 72 disposed along the margin of the image 71 in the display screen 70 which is recognized and/or perceived by the viewer. Here, the image 71 may be an image generated based on the laser light scanned by the scanning section and may correspond to the intermediate image surface which is formed in the second relay optical system 35 as described above. Since the mask 52 forms the image frame 72 in the display screen 70, excessive light in the display screen 70 is shielded to provide a sharp screen.

In the display screen 70, a gap area 73 which is brighter than the image frame 72 is formed between the image 71 and the image frame 72. The gap area 73 is provided between the rectangular-shaped image 71 and the image frame 72 at each of the four sides and is formed in a rectangular frame shape along the margin of the image 71. The gap area 73 is a white colored portion which is formed by incident stray light of the laser light emitted from the vertical scanning section 34 in the display screen 70.

With the gap area 73 provided in the display screen 70, the viewer may more easily recognizes when the image frame 72 is tilted with respect to the image 71 (e.g., when the optical unit 50 is tilted in the lens barrel 60). As illustrated in FIG. 4, one rectangular coordinate system, denoted by “a” and “b”, is defined along with the edges of the image 71 (e.g., image coordinate system). Another rectangular coordinate system (e.g., frame coordinate system), denoted by “α” and “β”, is defined along with the edges of the image frame 72. When the image frame 72 is aligned with respect to the image 71, a tilt angle, defined between the frame coordinate system and image coordinate system, is zero. On the other hand, if the image frame 72 is tilted with respect to the image 71, the tilt angle is θ and is greater than zero, as illustrated in FIG. 4. Thus, when the image frame 72 is tilted with respect to the image 71, the viewer may feel that the image 71 itself is tilted.

Using mask 52, the viewer recognizes the horizontal and vertical orientations of the image 71 in reference to the image frame 72 shielded by the mask 52 which is integrated with the optical unit 50. In one or more arrangements, the mask 52 is integrated with the optical unit 50 and is located near the viewer's eye. Thus, when the image frame 72 formed by the mask 52 is tilted due to the tilted optical unit 50 as illustrated by the two-dot chain line in FIG. 4, the viewer will feel that the image 71 itself is tilted.

Accordingly, in the RSD 1, in order for the prevention of the tilt of the image frame 72 in the display screen 70, it is necessary to adjust an angle (i.e., the tilt angle θ as shown in FIG. 4), on a plane vertical to the optical axis of the ocular lens 40, of the optical unit 50 which is housed in the lens barrel 60 together with the ocular lens 40. Hereinafter, a structure for adjusting the angle (i.e., the tilt) of the optical unit 50 of the RSD 1 of the present embodiment will be described in further detail.

In the RSD 1 of the present example embodiment, the optical unit 50 is fixed to the ocular lens 40, and the optical unit 50 and the ocular lens 40 are housed in the lens barrel 60. Note that the optical unit 50 may be formed integrally with the ocular lens 40. The optical axis of the ocular lens 40 coincides with the center of the optical unit 50. Here, the center of the optical unit 50 corresponds to the center of the surrounding shape of the mask 52 of the optical unit 50 (see point C in FIG. 2). The ocular lens 40 and the optical unit 50, fixed to each other, might not be relatively rotatable around the optical axis of the ocular lens 40.

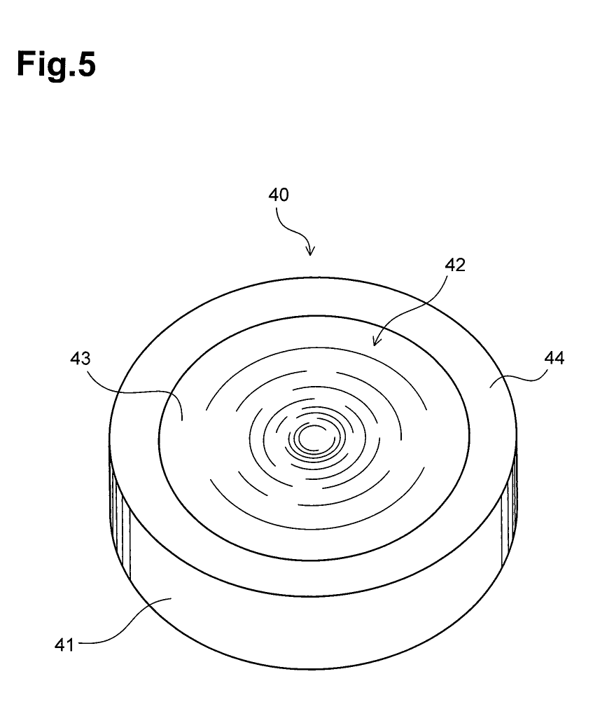

The ocular lens 40 will be described in further detail with reference to FIG. 5. As illustrated in FIG. 5, the ocular lens 40 has a substantially cylindrical outer shape as a whole and has a circular outer shape when viewed along the optical axis of the ocular lens 40. The ocular lens 40 has an outer circumferential surface 41 along the cylindrical surface. An axial center of the outer circumferential surface 41 is in agreement with the optical axis of the ocular lens 40.

The ocular lens 40 includes a lens surface 43 which forms a recess 42. In the illustrated example, the recess 42 is circular when viewed along the optical axis of the ocular lens 40. The center of the circular-shaped recess 42 is in alignment with the axial center of the outer circumferential surface 41 when viewed along the optical axis of the ocular lens 40. The lens surface 43 which forms the recess 42 is formed as a substantially spherical concave surface.

The ocular lens 40 may also include, on the side at which the recess 42 is formed, an end surface 44 formed in the circumference of the recess 42. The end surface 44 is formed continuously with the lens surface 43 which forms the recess 42. In one example, the end surface 44 may be an annular flat portion formed over the entire circumference of the recess 42. The end surface 44 is formed along a plane which is vertical to the optical axis of the ocular lens 40.

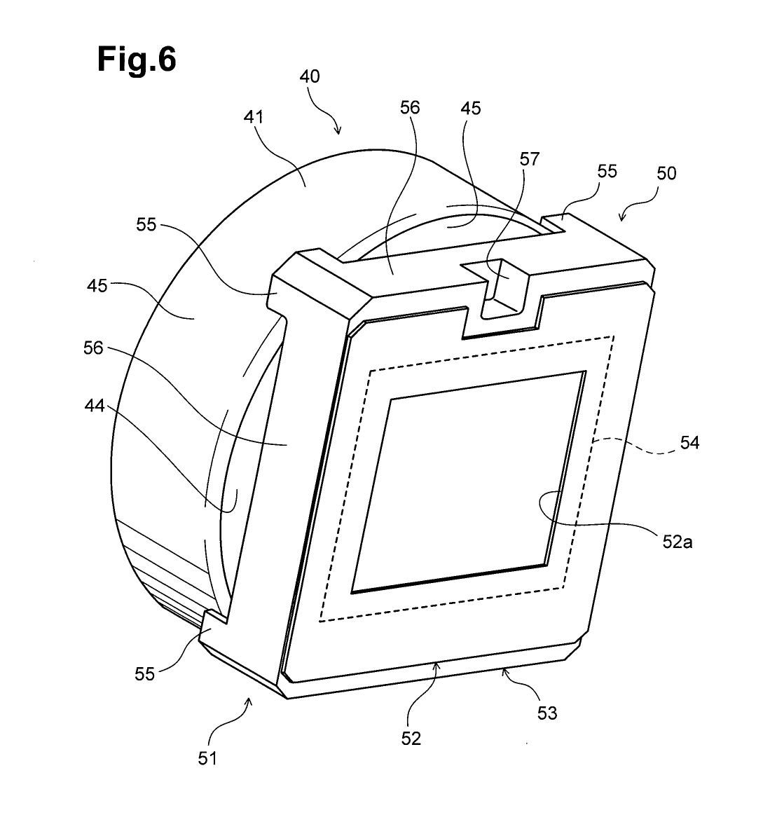

The ocular lens 40 including these portions of various shapes is fixed to the optical unit 50. In particular, as illustrated in FIG. 6, the ocular lens 40 is mounted on the optical unit 50 at the side opposite to the mask 52. In the integrated structure of the ocular lens 40 and the optical unit 50, the mask 52 is mounted on a laser light incident side of the optical unit 50.

In one or more arrangements, the optical unit 50 may further include retainer portions 55 to retain the ocular lens 40. The retainer portions 55 retain the ocular lens 40 such that the optical axis of the ocular lens 40 coincides with the central position of the surrounding shape of the mask 52.

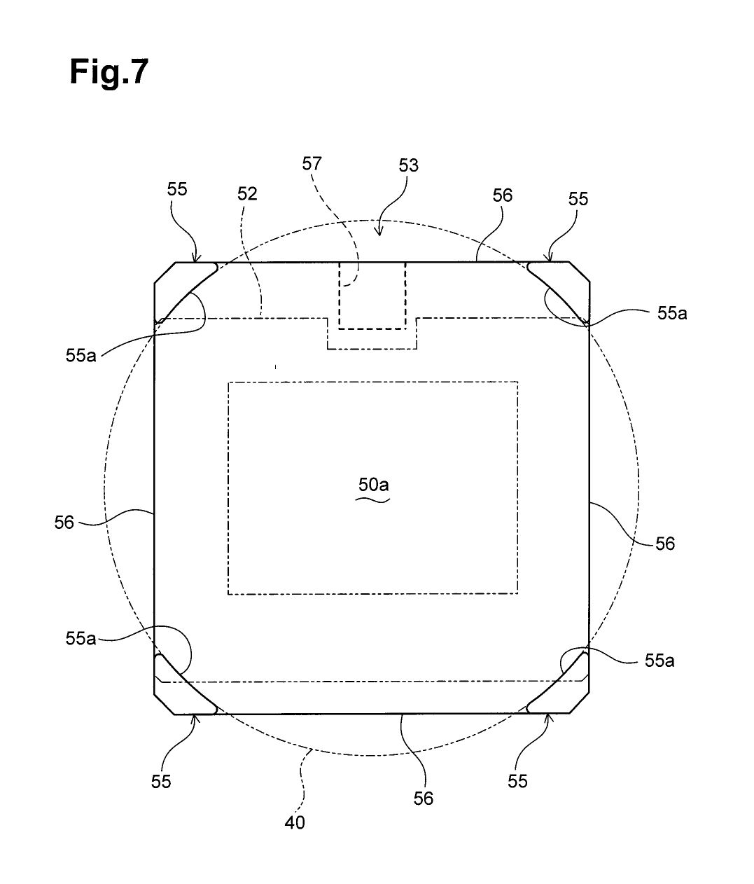

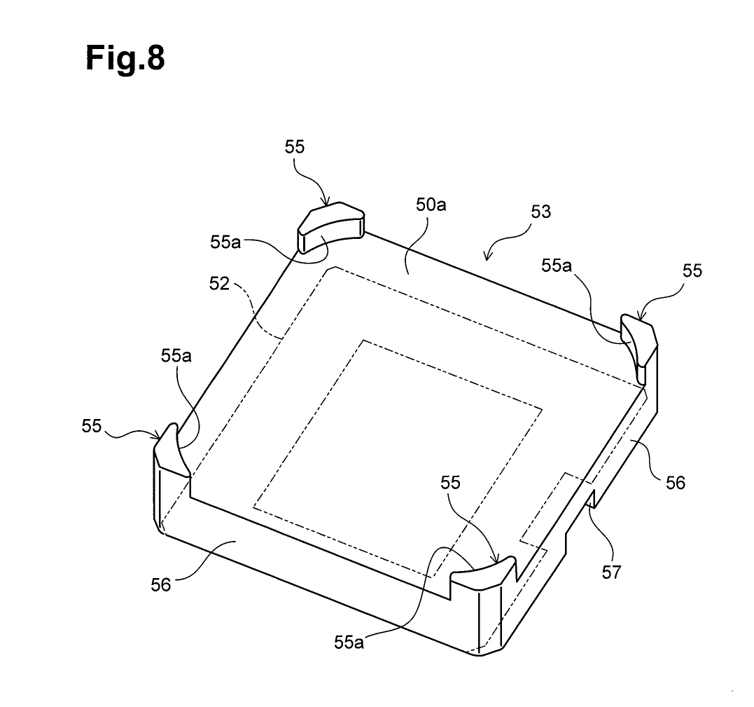

As illustrated in FIGS. 7 and 8, the retainer portions 55 are formed as projections extending substantially vertically from the casing 53 at the side opposite to the mask 52 in the optical unit 50. Each of the retainer portions 55 includes a retaining surface 55a which conforms to the outer circumferential surface 41 of the ocular lens 40. Accordingly, in one example, the retainer portions 55 retain the ocular lens 40 by virtue of the retaining surfaces 55a being in contact with the outer circumferential surface 41 of the ocular lens 40.

The optical unit 50 includes a plurality of (for example, four) retainer portions 55 and retains the ocular lens 40 with the retaining surfaces 55a being in contact with the outer circumferential surface 41 from a plurality of circumferential directions of the ocular lens 40. The ocular lens 40 is positioned adjacent to the retainer portion 55 in a plane vertical and perpendicular to the optical axis of the ocular lens 40. In a state in which the ocular lens 40 is positioned by the retainer portions 55, the optical axis of the ocular lens 40 is aligned with the central position (see point C in FIG. 2) of the surrounding shape of the mask 52.

In the present example embodiment, the retainer portions 55 are provided at four corners of the rectangular shaped exit pupil expander 51. Thus, the retaining surfaces 55a of the diagonally opposite retainer portions 55 substantially face each other. Thus, in one example, the ocular lens 40 is retained by the optical unit 50 while fitting within the four retainer portions 55 located at substantially regular intervals along the circumferential direction of the outer circumferential surface 41. The ocular lens 40 and the optical unit 50 are fixed to each other with, for example, the outer circumferential surface 41 of the ocular lens 40 and the retaining surface 55a of the retainer portion 55 attached to each other with an adhesive.

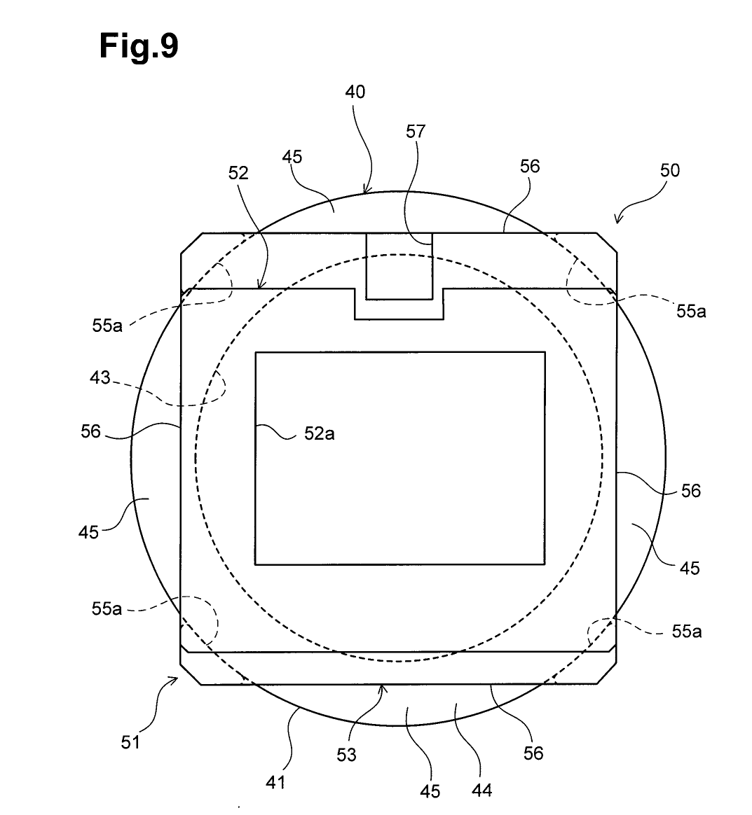

According to another aspect, the ocular lens 40 has an outside diameter, of which a periphery protrudes from the rectangular-shaped exit pupil expander 51 when formed integrally with or combined with the optical unit 50. That is, a portion of the ocular lens 40 forming the outer circumferential surface 41 may protrude from the four sides of the exit pupil expander 51 when viewed along the optical axis of the ocular lens 40 when the ocular lens 40 is retained within the exit pupil expander 51. Accordingly, as illustrated in FIG. 9, lens protruding sections 45 correspond to peripheral portions of the ocular lens 40 protruding from the exit pupil expander 51 when viewed along the optical axis of the ocular lens 40.

The lens protruding sections 45 protrude from side surfaces 56 which form four sides of the rectangular-shaped exit pupil expander 51 when viewed along the optical axis of the ocular lens 40. The lens protruding sections 45 represent portions of the outer circumferential surface 41 of the ocular lens 40. That is, the ocular lens 40 has four lens protruding sections 45 at four locations around the exit pupil expander when retained by the optical unit 50.

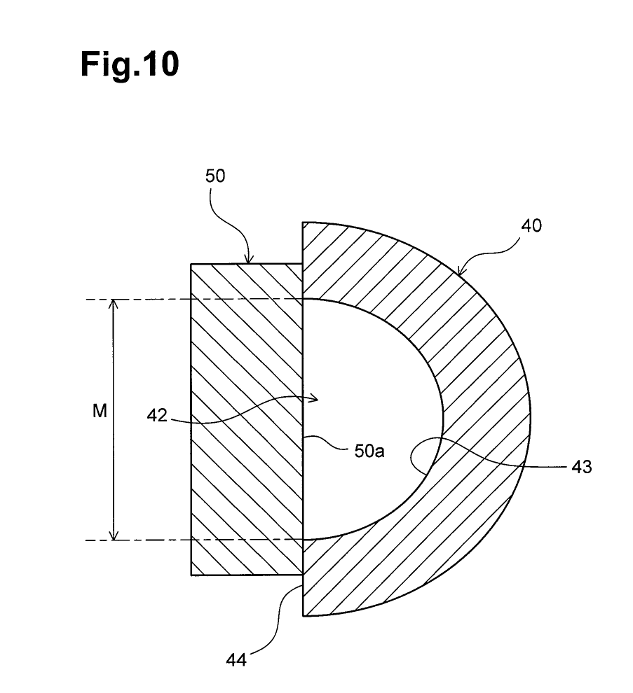

In the integrated structure of the ocular lens 40 and the optical unit 50, the recess 42 of the ocular lens 40 is closed by the exit pupil expander 51. In particular, as illustrated in FIG. 10, the ocular lens 40 is integrated with the optical unit 50 in a state in which the recess 42 is covered by an opposing surface 50a of the optical unit 50.

The opposing surface 50a of the optical unit 50 is formed by the exit pupil expander 51 of the optical unit 50. When the ocular lens 40 and the optical unit 50 are combined, the lens surface 43 of ocular lens 40 is configured to oppose or face the opposing surface 50a. Accordingly, in such arrangements, the retainer portions 55 which retain the ocular lens 40 in the optical unit 50 may be formed on the opposing surface 50a. Moreover, the ocular lens 40 is thus supported by the optical unit 50 with the end surface 44 of the ocular lens 40 being in contact with the opposing surface 50a.

An inner diameter of the end surface 44 of the ocular lens 40 (see dimension M in FIG. 10) and the size of the opposing surface 50a of the optical unit 50 are determined such that an opening area (e.g., having a diameter M) of the recess 42 of the ocular lens 40 might be equal to or less than the size of the opposing surface 50a of the optical unit 50. Thus, in the state in which the ocular lens 40 and the optical unit 50 are integrated or otherwise combined with each other, the entire opening of the recess 42 of the ocular lens 40 is covered with the opposing surface 50a of the ocular lens 40 and as a result, the recess 42 is closed/covered.

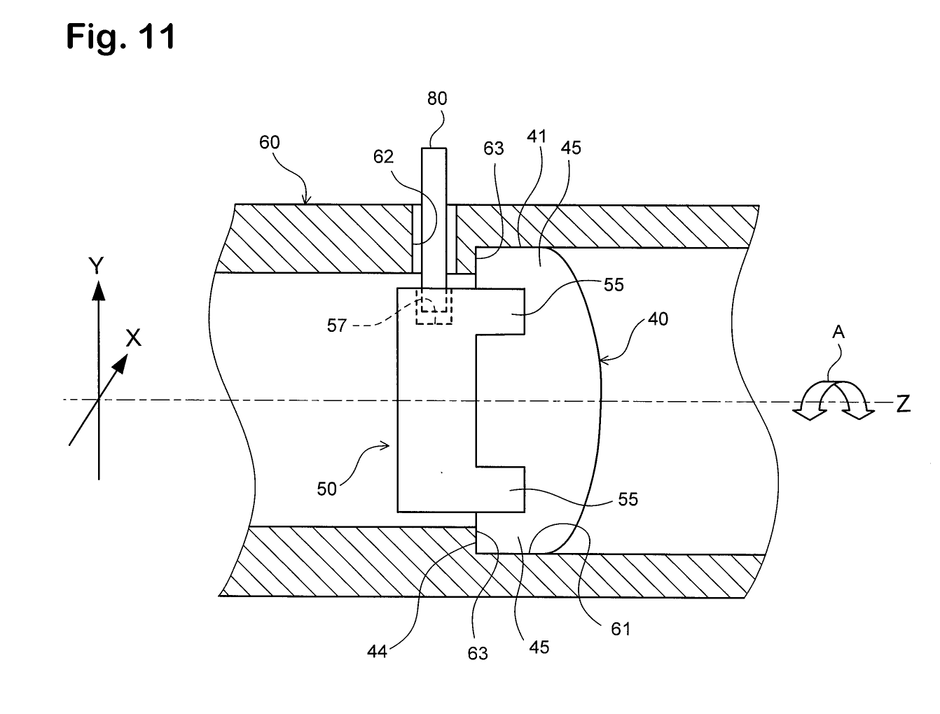

The ocular lens 40 and the optical unit 50 which are integrated with each other as described above are housed in the lens barrel 60 as illustrated in FIG. 11. When the ocular lens 40 and the optical unit 50 are housed in the lens barrel 60, the optical axis of the ocular lens 40 and the center of the optical unit 50 are located along a Z-axis corresponding to a central axis of the lens barrel 60.

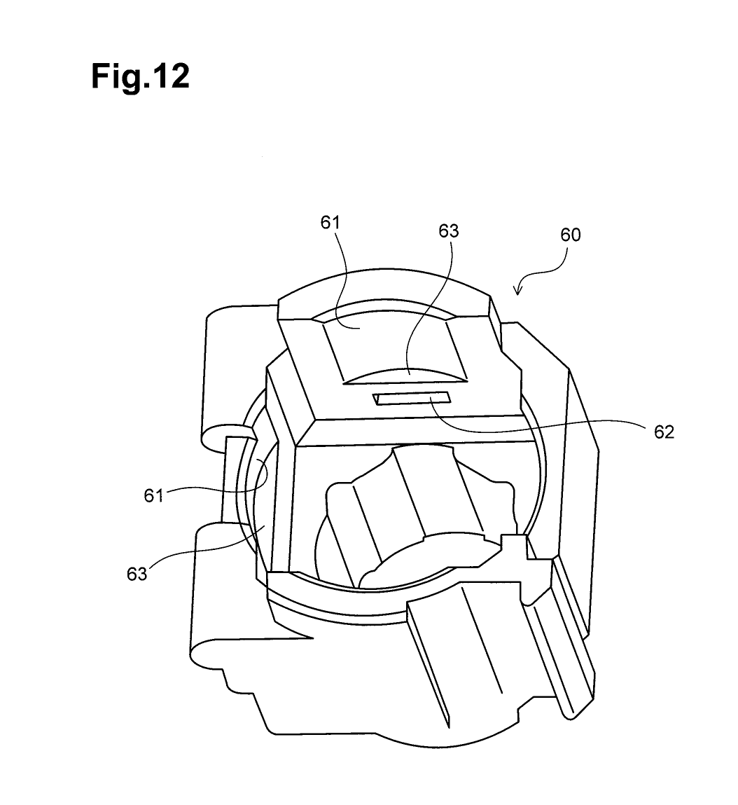

The lens barrel 60 which houses the ocular lens 40 and the optical unit 50 has an inner circumferential surface 61 which is configured to receive and support the ocular lens 40 as illustrated in FIGS. 11 and 12. The inner circumferential surface 61 of the lens barrel 60 supports the ocular lens 40 in manner in which the ocular lens 40 is rotatable around the optical axis of the ocular lens 40 when the outer circumferential surface 41 of the ocular lens 40 and the inner circumferential surface 61 are in contact with each other. In one example, the inner circumferential surface 61 of the lens barrel 60 is a sliding surface with respect to the outer circumferential surface 41 of the ocular lens 40. That is, the lens barrel 60 allows for the rotation of the ocular lens 40 around the optical axis of the ocular lens 40 when the inner circumferential surface 61 of the lens barrel 60 is in contact with the outer circumferential surface 41 of the ocular lens 40 housed together with the optical unit 50. For example, surface 61 may be a low-friction surface or may include one or more materials (e.g., plastics, metals, liquids, etc.) that allow for easier rotation and movement. In particular, the inner circumferential surface 61 of the lens barrel 60 supports rotation of the ocular lens 40 around the optical axis, without changing a relative position of the ocular lens 40 with respect to the lens barrel 60 on an X-Y plane vertical and perpendicular to the optical axis (see FIG. 11).

Accordingly, it might not be necessary for the inner circumferential surface 61 of the lens barrel 60 supporting the ocular lens 40 to be a continuous surface along the circumferential direction thereof. Alternatively, the inner circumferential surface 61 may be constituted by a plurality of surfaces which are partially in contact with the outer circumferential surface 41 of the ocular lens 40. When housed in the lens barrel 60, the ocular lens 40 rotates around the Z-axis with the outer circumferential surface 41 as a sliding surface with respect to the inner circumferential surface 61 of the lens barrel 60 (see arrow A in FIG. 11).

As the ocular lens 40 rotates around the Z-axis, the optical unit 50 integrated with the ocular lens 40 also rotates around the Z-axis. Thus, one or more gaps may exist between the optical unit 50 and the inner circumferential surface of the lens barrel 60 when the optical unit 50 is housed in the lens barrel 60 such that the optical unit 50 might rotate around the Z-axis at least in a predetermined range. In particular, the shape of the inner circumferential surface allows for the rotation of the optical unit 50 accompanying the rotation of the ocular lens 40 around the Z-axis.

As described above, the ocular lens 40 and the optical unit 50 which are integrated with each other are housed in the lens barrel 60 so as to be rotatable in an integrated manner. In such an arrangement and configuration, the rotational position around the Z-axis of the optical unit 50 is adjusted using the outer circumferential surface 41 of the ocular lens 40 as the sliding surface with respect to the lens barrel 60. That is, the rotational position of the optical unit 50 around the Z-axis with respect to the lens barrel 60 is adjusted by the relative rotation of the ocular lens 40 and the lens barrel 60. Here, the rotational position around the Z-axis of the optical unit 50 can be considered as an angle (i.e., the tilt) of the optical unit 50 on the X-Y plane (e.g., the surface vertical to the Z-axis).

For the adjustment of the rotational position of the optical unit 50 with respect to the lens barrel 60 around the Z-axis, the outer circumferential surface 41 of the ocular lens 40 functions as a positioning surface for the positioning of the integrated structure of the ocular lens 40 and the optical unit 50 with respect to the lens barrel 60. In the optical unit 50, as described above, the rotational position around the optical axis of the ocular lens 40 can be adjusted with the rotation of the ocular lens 40 against the inner circumferential surface 61 on which the ocular lens 40 is supported.

As illustrated in, for example, FIG. 6, the optical unit 50 includes an engaging recess 57 for the adjustment of its rotational position. In one example, the rotation of the integrated structure of the ocular lens 40 and the optical unit 50 may be performed by applying a force to the engaging recess 57. The engaging recess 57 is formed on one side surface 56 of the casing 53 of the exit pupil expander 51. The engaging recess 57 is formed as a cut-away portion at which the side surface 56 is partially opened.

As illustrated in FIG. 11, a rotation manipulator 80 is used for the adjustment of the rotational position of the optical unit 50. The rotation manipulator 80 is a cylindrical member capable of engaging with the engaging recess 57 of the optical unit 50. The rotation manipulator 80 is placed in/mated with the engaging recess 57 of the optical unit 50 from outside the lens barrel 60.

The rotation manipulator 80 may be manipulated in a variety of ways including by a machine, such as an assembler, or manually by an operator. When the rotation manipulator 80 is manipulated when placed in the engaging recess 57, a force may be applied to the optical unit 50 in the rotational direction for the adjustment of the rotational position. The lens barrel 60 includes an opening 62 through which the optical unit 50 in the lens barrel 60 can be accessed from outside the lens barrel 60 (see FIGS. 11 and 12).

Through the opening 62, the rotation manipulator 80 can be placed in the engaging recess 57 of the optical unit 50 housed in the lens barrel 60. The size and shape of the opening 62 formed in the lens barrel 60 are determined such that the movement of the rotation manipulator 80 (e.g., when engaged with the engaging recess 57) may be allowed in a range necessary for the adjustment of the rotational position of the optical unit 50.

As described above, the rotational position of the optical unit 50 is adjusted by using the engaging recess 57 formed in the optical unit 50 and generating and applying a force for the rotation of the optical unit 50 through the rotation manipulator 80. That is, in the present example embodiment, the engaging recess 57 formed in the optical unit 50 functions as a rotation adjusting section configured to receive a force causing the rotation of the ocular lens 40 and the optical unit 50 housed in the lens barrel 60.

In one or more arrangements, for example, the engaging recess 57 may be exposed at least on the side surface 56 to allow for the engagement of the rotation manipulator 80 with the engaging recess 57 via the opening 62 when the optical unit 50 is housed in the lens barrel 60. Various structures for facilitating and allowing rotation of the rotating ocular lens 40 and the optical unit 50 to adjust the rotational position of the optical unit 50 may be used and is not limited to the example structures and configurations described herein.

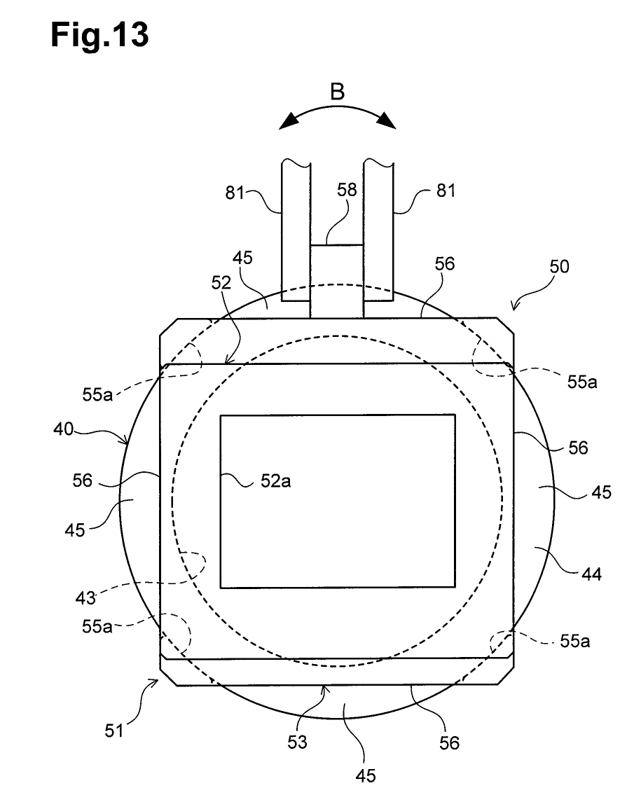

According to one or more configurations, the rotation adjusting section of the optical unit 50 may include a protruding portion 58 extending from one of the side surfaces 56 of the exit pupil expander 51 as illustrated in FIG. 13. With this structure, rotation of the optical unit 50 around the Z-axis with respect to the optical unit 50 is facilitated by operation of a holding manipulator 81 which holds the protruding portion 58 (see arrow B).

In the structure illustrated in FIG. 13, if the protruding portion 58 protrudes from the lens barrel 60, the lens barrel 60 is provided with an opening through which the protruding portion 58 is able to protrude outside of the lens barrel 60. Moreover, if the holding manipulator 81 is inserted inside the lens barrel 60, the lens barrel 60 is provided with an opening through which the holding manipulator 81 is inserted inside the lens barrel 60. The size and shape of the opening through which the protruding portion 58 or the holding manipulator 81 is inserted are determined such that the rotation of the optical unit 50 might be allowed in a range necessary for the adjustment of the rotational position of the optical unit 50.

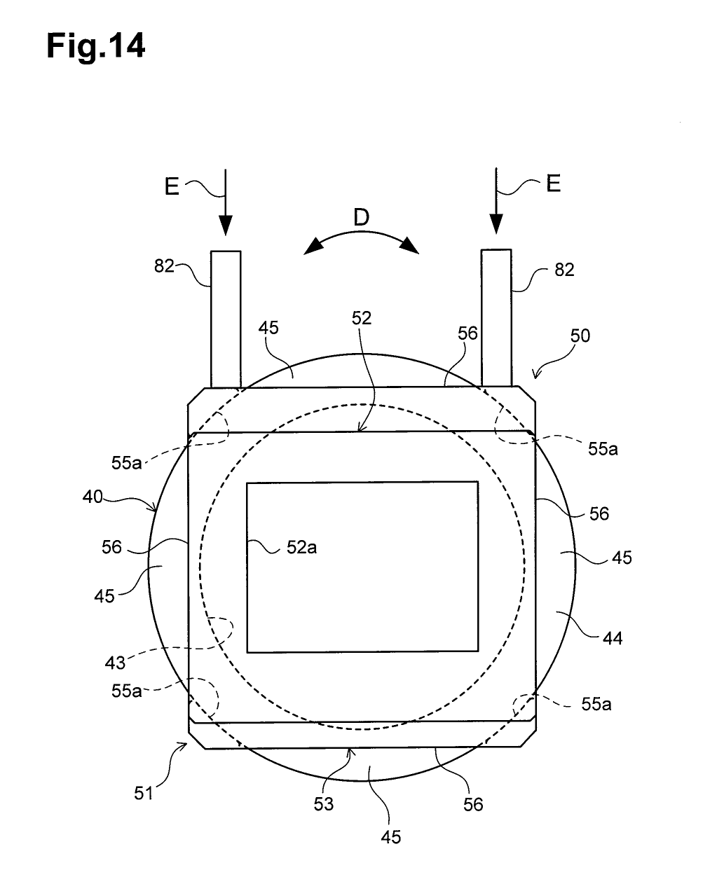

As another example method for adjustment of the rotational position of the optical unit 50, the optical unit 50 may be pressed using a press manipulator 82 as illustrated in FIG. 14. With this structure (e.g., press manipulator 82), the optical unit 50 housed in the lens barrel 60 is able to rotate around the Z-axis when pressed by the press manipulator 82 (see arrow D). For example, as illustrated in FIG. 14, one of the side surfaces 56 of the exit pupil expander 51 in the optical unit 50 is pressed at both ends thereof by the press manipulator 82 (see arrow E).

In the method and configuration illustrated in FIG. 14, the lens barrel 60 includes an opening through which the press manipulator 82 is inserted in the lens barrel 60. The size and shape of the opening through which the press manipulator 82 is inserted are determined such that the rotation of the optical unit 50 might be allowed in a range necessary for the adjustment of the rotational position of the optical unit 50.

In the RSD 1 of the present embodiment, the rotation adjusting section configured to receive a force for the rotation of the ocular lens 40 and the optical unit 50 housed in the lens barrel 60 is provided in the optical unit 50 as the engaging recess 57. In some arrangements, the rotation adjusting section for the adjustment of the rotational position of the optical unit 50 may be provided in the ocular lens 40 instead of or in addition to a rotation adjusting section in optical unit 50 (e.g., engaging recess 57).

Accordingly, the tilt of the image frame 72 with respect to the image 71 in the display screen 70 is prevented through the adjustment of the rotational position around the Z-axis of the optical unit 50 housed in the lens barrel 60 (see FIG. 4).

The lens protruding sections 45 of the ocular lens 40 are used for the positioning of the ocular lens 40 with respect to the lens barrel 60 along the Z-axis. In particular, the end surface 44, at the lens protruding sections 45 of the ocular lens 40, is used as a positioning surface to contact the lens barrel 60. Thus, as illustrated in FIGS. 11 and 12, a positioning surface 63 with which the end surface 44, at the lens protruding sections 45 of the ocular lens 40, is brought into contact is formed along the inner circumferential surface of the lens barrel 60. The positioning surface 63 is formed as a flat portion perpendicular to the Z-axis of the lens barrel 60 extending from the inner circumferential surface 61 which serves as a sliding surface for the outer circumferential surface 41 of the ocular lens 40. Additionally, as illustrated in FIGS. 11 and 12, the positioning surface 63 is formed as a stepped surface where the inner diameter of the lens barrel 60 increases with respect to a portion of the lens barrel 60 where the optical unit 50 is located. The portions of the lens protruding sections 45 protruding from the optical unit 50 along the plane perpendicular to the Z-axis are made to abut the positioning surface 63. By allowing the lens protruding sections 45 to abut against positioning surface 63, the ocular lens 40 may be appropriately and correctly positioned with respect to the lens barrel 60 along the Z-axis.

As described above, the ocular lens 40 is positioned with respect to the lens barrel 60 along the optical axis direction using the end surface 44 (e.g., the surface of the lens protruding sections 45 at the side of the exit pupil expander 51 protruding from the four sides of the exit pupil expander 51) as the contact surface with respect to the lens barrel 60 along the optical axis direction. The ocular lens 40 housed in the lens barrel 60 is positioned along the X-Y plane with the outer circumferential surface 41 contacting the inner circumferential surface 61 of the lens barrel 60, and along the Z-axis with the end surface 44, at the lens protruding sections 45, contacting the positioning surface 63 of the lens barrel 60.

As described above, the integrated structure of the ocular lens 40 and the optical unit 50 is fixed to the lens barrel 60 after the rotational position of the optical unit 50 is adjusted and the optical unit 50 is positioned along the X-Y plane and the Z-axis via the ocular lens 40. The integrated structure of the ocular lens 40 and the optical unit 50 may be fixed to the lens barrel 60 by, for example, attaching the contact surface of the ocular lens 40 (e.g., the outer circumferential surface 41), to the lens barrel 60 with an adhesive.

As described above, with the RSD 1 according to the present embodiment, the following effects can be expected.

The RSD 1 according to the present embodiment includes the optical unit 50 and a lens barrel 60. The optical unit 50 is disposed in the vicinity area defined between the scanning section and the ocular lens 40 (e.g., proximate to or within the area between the scanning section and the ocular lens 40). The vicinity area includes the image surface position. The lens barrel 60 houses the ocular lens 40 and the optical unit 50. The optical unit 50 includes an optical effect device which produces an optical effect having directivity to at least a portion of the laser light. For example, the optical unit 50 is constituted by the exit pupil expander 51 and the mask 52 which are integrated with each other. The exit pupil expander 51 enlarges an effective diameter of the exit pupil, which is formed by the ocular lens 40, by branching the laser light. The mask 52 shields the periphery of the image based on the laser light scanned by the scanning section. The ocular lens 40 has a circular outer shape when viewed along the optical axis of the ocular lens 40. The lens barrel 60 includes the inner circumferential surface 61 on which the ocular lens 40 is supported to be rotatable around the optical axis thereof in a state where the outer circumferential surface 41 of the ocular lens 40 is in contact with the inner circumferential surface 61 of the lens barrel 60. Additionally, the optical unit 50 may be fixed to the ocular lens 40. In the optical unit 50, the rotational position around the optical axis of the ocular lens 40 can be adjusted with the rotation of the ocular lens 40 rotatably supported on the inner circumferential surface 61. Thus, in the structure in which the optical system includes the optical unit 50 and the ocular lens 40, the optical unit 50 and the ocular lens 40 may be more easily assembled to the lens barrel 60. Furthermore, the positional adjustment of the optical unit 50 along the rotational direction may be easier, and the positioning accuracy of the optical unit 50 and the ocular lens 40 with respect to the lens barrel 60 may be improved.

In a particular example, in a structure in which the ocular lens 40 and the optical unit 50 are separately attached to the lens barrel 60, there may be difficulty in assembling the ocular lens 40 and the optical unit 50 to the lens barrel 60 and in positioning the lens 40 and optical unit 50 with sufficient positioning accuracy relative to the lens barrel 60. Since the optical unit 50 has a rectangular outer shape, it is difficult to correct the tilt of the optical unit 50 within the image surface in the lens barrel 60. However, using the RSD 1 of the present embodiment, since the ocular lens 40 and the optical unit 50 are integrated with each other and the outer circumferential surface 41 of the ocular lens 40 which has a circular outer shape is used as the positioning surface with respect to the lens barrel 60, the ocular lens 40 and the optical unit 50 can be assembled more easily to the lens barrel 60 with higher positioning accuracy. For example, the optical unit 50 may use the circular outer shape of the ocular lens 40, rather than its own rectangular outer shape, as the sliding surface with respect to the lens barrel 60, thereby making the adjustment of the rotational position easier. With this structure, misalignment between the mask 52 of the optical unit 50 and the ocular lens 40 and the tilt in the shape of the mask 52 with respect to the shape of the intermediate image surface (e.g., the display image formed in the lens barrel 60) are prevented and impairment of image quality is avoided. In a particular example, since the optical unit 50 is assembled to the lens barrel 60 with increased accuracy, problems including failure to achieve desired diffraction characteristics and consequent impairment to image quality caused by the tilt of the exit pupil expander 51 relative to the diffraction grating 54 can be avoided.

As also discussed, in the RSD 1 of the present embodiment, the exit pupil expander 51 may include the engaging recess 57 as a rotation adjusting section which receives the effect for the rotation of the ocular lens 40 and the optical unit 50. Thus, the rotation adjusting section can be more easily formed when creating the casing 53 which constitutes the exit pupil expander 51.

Additionally, in accordance with one or more aspects of the RSD 1 of the present embodiment, the optical unit 50 includes the retainer portion 55 which retains the ocular lens 40 such that the optical axis of the ocular lens 40 coincides with the central position of the surrounding shape of the mask 52. Thus, the ocular lens 40 can be more easily positioned to the optical unit 50.

Further, according to additional aspects of the RSD 1 of the present embodiment, the exit pupil expander 51 is formed in a rectangular shape when viewed along the optical axis of the ocular lens 40 while the retainer portions 55 are provided at four corners of the exit pupil expander 51. Moreover, a portion of the ocular lens 40 forming the outer circumferential surface 41 protrudes from the four sides of the exit pupil expander 51 when viewed along the optical axis of the ocular lens 40 when the ocular lens 40 is retained by the exit pupil expander 51 at the retainer portions 55. With this structure, the optical axis of the ocular lens 40 can be more efficiently positioned to the lens barrel 60 along the X-Y plane with the combination of the ocular lens 40 which is circular and the optical unit 50 which is rectangular when viewed along the optical axis of the ocular lens 40.

Still further, in the RSD 1 of the present embodiment, the ocular lens 40 is positioned with respect to the lens barrel 60 along the optical axis direction using the end surface 44 (e.g., the surface of the lens protruding sections 45 at the side of the exit pupil expander 51 protruding from the four sides of the exit pupil expander 51), as the contact surface with respect to the lens barrel 60 along the optical axis direction. Thus, the ocular lens 40 and the optical unit 50 can be positioned more easily and more accurately to the lens barrel 60 along the Z-axis.

In the RSD 1 of the present embodiment, the ocular lens 40 includes the lens surface 43 which forms a circular recess 42 (when viewed along the optical axis of the ocular lens 40). The recess 42 is enclosed by the exit pupil expander 51. With this structure, adhesion of dust in the recess 42 of the ocular lens 40 after the ocular lens 40 and the optical unit 50 are assembled to the lens barrel 60 can be prevented more effectively.

According to one or more aspects, the configuration of the optical unit, lens and lens barrel may be applied and/or used to a variety of image generators. For example, in the RSD 1 of the embodiment illustrated in FIG. 1, the light source section 6, the horizontal scanning section 32, and the vertical scanning section 34 are used to generate image light, i.e., as an example of an image generator. Alternatively or additionally, image generators may also include two-dimensional display elements (e.g., liquid crystal display (LCD), digital mirror devices (DMD), etc.).

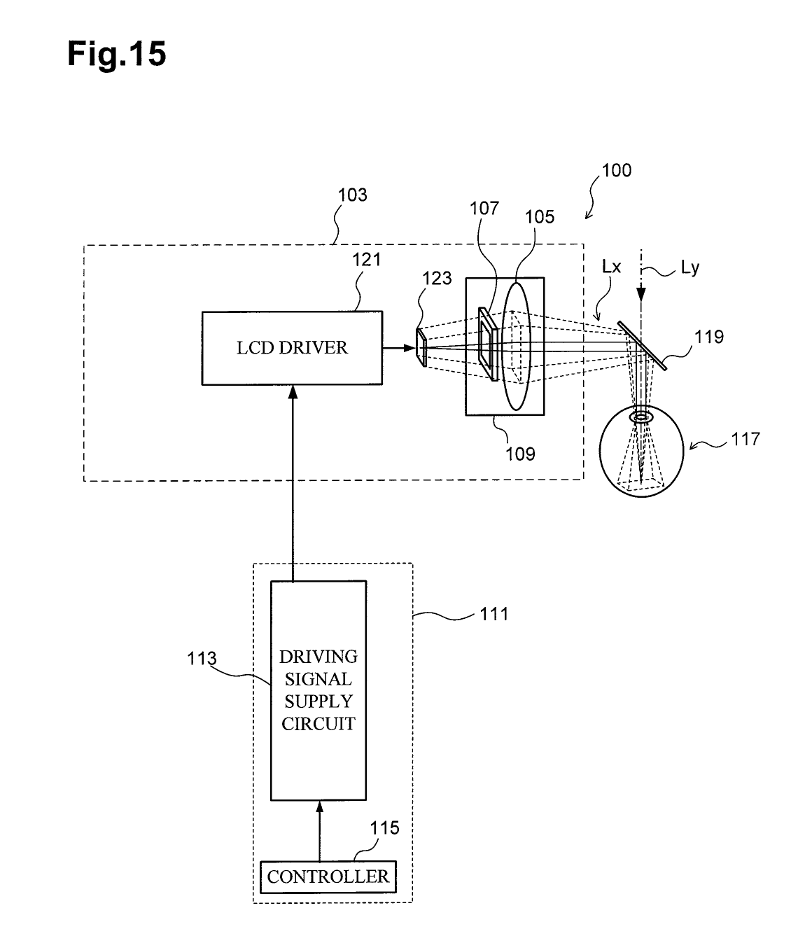

FIG. 15 illustrates another example embodiment of an image display device having an LCD (liquid crystal display) image generator. Similar to the RSD of FIG. 1, image display device 100 may include a drive controller 111 configured to generate an image signal in accordance with, for example, content data stored in a storage device such as internal or external memories. Drive controller 111 may include a controller 115 and a driving signal supply circuit 113. In one arrangement, the controller 115 may be configured to control the functionality of the image display device 100. For example, the controller 115 may control driving signal supply circuit 113 to output a signal to LCD driver 121. LCD driver 121 may then control one or more pixels of a LCD display 123 to generate an image corresponding to the signal output by the driving signal supply circuit 113. The image light is projected through the image barrel 109 having an optical unit 107 (e.g., a grating or a mask) and lens 105. The configuration of the barrel 109, optical unit 107 and lens 105 may be similar to or the same as the configuration of lens 40, optical unit 50 and lens barrel 60 (all of FIG. 11). The light/image output from lens barrel 60 may then be projected onto a half-mirror 119, for example, which may then direct the light/image output onto a viewer's eye 117 (e.g., incident to a viewer's eye 117).

While the specific embodiments have been illustrated and described, numerous modifications are possible without departing from the spirit of the invention, and the scope of protection is only limited by the scope of the accompanying Claims.

What is claimed is:

1. An image display device, comprising:
an image generator configured to generate a image light that represents a two-dimensional image;
an ocular lens configured to direct the image light generated by the image generator to be incident on a viewer's eye;
an optical unit disposed between the image generator and the ocular lens, the optical unit including an optical effect device configured to modify the image light to be asymmetrical along at least one axis perpendicular to an optical axis of the optical unit;
a lens barrel configured to house the ocular lens and the optical unit,
wherein:
the ocular lens comprises a circular outer shape when viewed along an optical axis of the ocular lens;
the lens barrel includes an inner circumferential surface configured to support the ocular lens for rotation around the optical axis of the ocular lens when an outer circumferential surface of the ocular lens contacts the inner circumferential surface of the lens barrel; and
a rotational position of the optical unit around the optical axis of the ocular lens is adjustable by rotating the ocular lens.

2. The image display device of claim 1, wherein the image generator comprises:
a light source section configured to emit a light beam;
a scanning section configured to convert the light beam into the image light by two-dimensionally scanning the light beam.

3. The image display device of claim 1, wherein the optical unit comprises at least one of an exit pupil expander and a mask,
wherein the exit pupil expander is configured to enlarge an effective diameter of an exit pupil formed by the ocular lens, by branching the light beam, the exit pupil expander being disposed between the scanning section and the ocular lens, and
wherein the mask is configured to shield a periphery of the two-dimensional image.

4. The image display device of claim 3, wherein the optical unit includes the mask.

5. The image display device according to claim 3, wherein the optical unit includes retainer portions configured to retain the ocular lens, wherein the optical axis of the ocular lens coincides with a central position of the at least one of the mask and the exit pupil expander when the ocular lens is retained by the retainer portions.

6. The image display device according to claim 5, wherein:
the optical unit comprises a rectangular shape when viewed along the optical axis of the ocular lens;
each of the retainer portions is disposed at a corner of the optical unit; and
portions of the ocular lens when viewed along the optical axis of the ocular lens protrude from four sides of the optical unit when the ocular lens is retained by the optical unit with the retainer portions.

7. The image display device of claim 3, wherein the optical unit includes the exit pupil expander.

8. The image display device according to claim 7, wherein the ocular lens includes a recessed lens surface, wherein the recessed lens surface is circular when viewed along the optical axis of the ocular lens, and the recessed lens surface being covered by the exit pupil expander.

9. The image display device of claim 3, wherein the optical unit includes the exit pupil expander and the mask.

10. The image display device according to claim 9 wherein the exit pupil expander and the mask are integrated with each other.

11. The image display device according to claim 10, wherein the ocular lens is positioned with respect to the lens barrel along the optical axis of the ocular lens using a surface of the portions of the ocular lens protruding from the sides of the optical unit as a contact surface with respect to the lens barrel along the optical axis of the ocular lens.

12. The image display device according to claim 1, wherein the optical unit further includes a rotation adjusting section configured to receive a force for rotation of the ocular lens and the optical unit.

13. The image display device according to claim 1, wherein the optical unit comprises a rectangular shape.

14. The image display device according to claim 1, wherein the image generator includes a two dimensional pixel array.
